(19) United States
(12) Patent Application Publication
(10) Pub. No.: US 2004/0125816 A1
(43) Pub. Date: Jul. 1, 2004

(54) Method and apparatus for providing a buffer architecture to improve presentation quality of images

(76) Inventors: Haifeng Xu, San Diego, CA (US); Joe Diamand, San Diego, CA (US); Ajay Luthra, San Diego, CA (US)

Correspondence Address: Kin-Wah Tong, Moser, Patterson & Sheridan, LLP, Suite 100, 595 Shrewsbury Avenue, Shrewsbury, NJ, 07702, US

(21) Appl. No.: 10/735,564

(22) Filed: Dec. 12, 2003

Related U.S. Application Data
(60) Provisional application No. 60/433,124, filed on Dec. 13, 2002.

(51) Int. Cl. H04L 12/28; H04L 12/56

(52) U.S. Cl. 370/411

(57) ABSTRACT

A method and apparatus that employ a buffer management architecture to address various video quality issues that may occur at a client player are disclosed. The present invention employs one or more buffers to assist in the scheduling and delivery of rendered content to a player's output system. In one embodiment, the system employs a packet buffer, a frame buffer and an image buffer. One useful advantage of the present invention is the control of these buffers to meet a predefined QoS, thereby ensuring factors that may negatively affect the QoS in the real-time transport of high bandwidth content will be minimized.

This application claims the benefit of U.S. Provisional Application No. 60/433,124 filed on Dec. 13, 2002, which is herein incorporated by reference.

### BACKGROUND OF THE INVENTION

1. Field of the Invention

The present invention generally relates to digital video processing and, more particularly, to a method and apparatus for improving video presentation quality.

2. Description of the Related Art

Consumer access to the Internet at broadband speeds is being heralded as the next great enabling technology that will usher in a new wave of compelling and innovative services and applications. An example of such services and applications is the streaming of high quality video content. Streaming media provides a flexible way to distribute multimedia content over the Internet because of the way in which the time needed to wait for a video, prior to being able to play the content, is minimized. With streaming technology, playback can begin after only a short segment has been received at the player. This is in contrast to schemes where the entire media clip is downloaded first, a potentially grating inconvenience for the consumer.

While streaming media does have its advantages, it also has its shortcomings. For instance, on a network where Quality of Service (QoS) guarantees do not exist, the service is susceptible to the uncertainties of a best effort delivery network. Many factors may affect the QoS of streaming of high quality video content, such as network congestion that causes larger than expected random packet arrival times (network jitter), loss of packets, resource constraints on the user's computer or media player and so on. Degradation may appear in the form of dropped frames, repeating frames or pausing the video presentation. Regardless of the factors, degradation of performance of the streaming of high quality video content will translate into a disappointing end-user experience. This in turn will impact the ability of service providers to promote their broadband application offerings.

Thus, there is a need for a method and apparatus that can address the challenges in the real-time transport of high bandwidth content over a network, e.g., an Internet Protocol (IP) network.

### SUMMARY OF THE INVENTION

In one embodiment, the present invention discloses a method and apparatus that employ a buffer management architecture called the Multi-Level Buffer Architecture (MLBA) to address various video quality issues that may occur at the client media player. The present invention employs one or more buffers to assist in the scheduling and delivery of rendered content to a media player's output system. In one embodiment, the MLBA system employs a packet buffer, a frame buffer and an image buffer. One useful advantage of the present invention is the control of these buffers to meet a predefined QoS, thereby ensuring factors that may negatively affect the QoS in the real-time transport of high bandwidth content will be minimized.

For example, the present invention can be used to mitigate the impact of the occasional MPEG-4 (Moving Picture Experts Group-4) video access unit that requires an inordinate number of CPU cycles to decode. By caching several image frames prior to rendering, the system is able to smooth out the effect of the occasional frame that requires more than the average time to decode.

Furthermore, since the present invention provides a unique buffer architecture, the overall system has the ability to anticipate pending image processing problems. For example, if the decoder is unable to keep up with the video frame rate, even with the image cache, then the present invention allows selective dropping of encoded video frames in order to free up the needed processing cycles. This selective dropping function can be implemented intelligently because the encoded video frames are also buffered. Knowing in advance the types of encoded video frames that will be decoded and rendered will allow intelligent selection of frames to be dropped, e.g., dropping B frames over P frames, to maintain a predefined QoS expected by the user or client.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a digital scheduling or buffering system;

FIG. 2 illustrates an exemplary packet buffer structure of the present invention;

FIG. 3 illustrates an exemplary frame buffer structure of the present invention;

FIG. 4 illustrates an exemplary image buffer structure of the present invention;

FIG. 5 illustrates a flowchart of a method for implementing the buffering scheme of the present digital scheduling system; and

FIG. 6 is a block diagram of the present digital scheduling system being implemented with a general purpose computer.

To facilitate understanding, identical reference numerals have been used, wherever possible, to designate identical elements that are common to the figures.

### DETAILED DESCRIPTION OF THE INVENTION

FIG. 1 is a block diagram depicting an exemplary embodiment of a digital scheduling or buffering system 100 that is deployed within a client device 102, e.g., a client computer or a media player. The client device 102 is in communication with a remote server 101, e.g., a streaming server via a network 103, e.g., the internet. Thus, in one embodiment, the remote server is forwarding in real-time high bandwidth content over a network.

Although the present invention is disclosed as having advantages within the context of streaming media, the present invention is not so limited. Namely, any other services that involve the real-time transport of high bandwidth content over a network will benefit from the present invention.

In one embodiment, the client device 102 may contain a network module 110, a decoder module 120 and a presentation module 130. These various modules operate cooperatively with the present digital scheduling system 100.

In operation, packets (audio and video) are received from the remote server 101 by the network module 110, which, in turn, forwards the packets to the decoder module 120 that employs a video decoder 122 and an audio decoder 124. The packets are decoded and forwarded to presentation module 130 which employs a video renderer 132 and an audio rendered 134. At the appropriate time, the video and audio data are provided to the client device's output subsystem.

In one embodiment, the digital scheduling system 100 or MLBA system assists in scheduling the delivery of rendered content to the player's output sub-system. Importantly, the scheduling method accounts for QoS to allow for the efficient control of media processing and presentation.

In one embodiment, the digital scheduling system 100 comprises a packet buffer 104, a frame buffer 106, an image buffer 108 and a controller 109. The buffers of the digital scheduling system 100 can be implemented to be physically or logically deployed with different modules of the client device.

For example, each module has its own set of buffers, with the network module 110 managing the packet buffers 104, the decoder module 120 managing the frame buffers 106, and the presentation module 130 managing the image buffer 108. Alternatively, the buffers can be controlled by a separate controller 109 that is independent from all the other modules. The packet buffer 104 is used to store arriving network packets. The frame buffer 106 is used to store reassembled encoded media frame, and the image buffer 108 is used to store decoded video frames that are queued up for rendering.

Typically, each video stream may require all three buffers while each audio stream only requires packet buffers and frame buffers. Although the present invention discloses a digital scheduling system 100 that comprises three different buffers, the present invention is not so limited. The present invention can be adapted to deploy more or less than these three types of buffers depending on the requirements of a particular implementation. For example, if the network 103 is such that the timely arrival of the packets and order of the arriving packets are guaranteed, then it may not be necessary to implement the packet buffer.

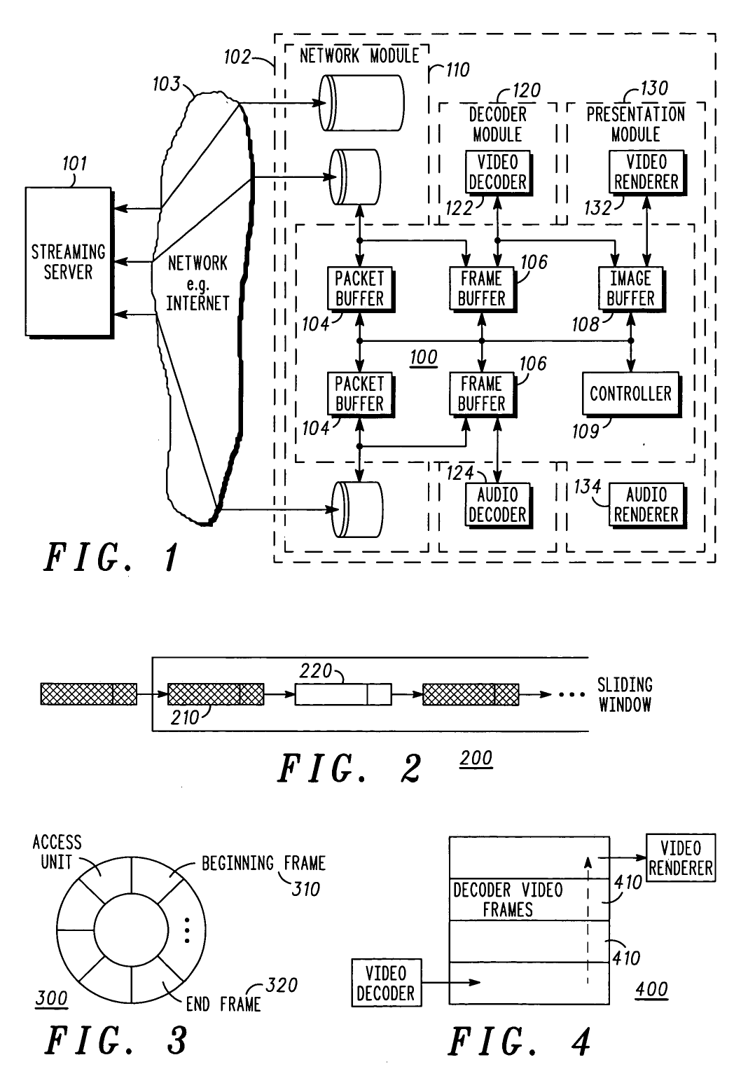

FIG. 2 illustrates an exemplary packet buffer structure 200 of the present invention. The packet buffer is implemented as a list of items of either type solid 210 or type hollow 220. Each solid item may contain one packet while a hollow item is a placeholder and contains no packets. When a packet arrives at the network module 110, the packet buffer manager, e.g., controller 109, calculates the slot position based on the packet's timestamp and/or sequence number information. If two adjacent packets do not have successive sequence numbers, a hollow item is inserted.

Uniquely, a sliding window is used in the packet buffer to accommodate the variable network delay inherent in some packet transmissions and to deal with conditions where packets arrive out-of-order. The size of sliding window is defined as its capacity for storing items with the allowable maximum network delay for packets, delta_t being computed using the following equation:

delta_t=(stream_bitrate*window_size)/packet_size (Equ. 1)

When a new packet arrives at the client site, the system checks its packet or frame number and decides if the packet can be stored. If the packet or frame number is smaller than that of the last processed packet, then the system handles the packet as an instance of packet loss and discards the packet. Otherwise, the packet will be inserted into the list sorted by packet or frame number.

When a solid item is popped from the sliding window, it will be sent to a media reassembler that is responsible for reconstructing the frame (i.e., access unit) as it existed prior to packetization.

FIG. 3 illustrates an exemplary frame buffer structure 300 of the present invention. In one embodiment, the frame buffer is designed using a ring data structure construct. A frame buffer manager, e.g., controller 109, is responsible for sending frames to the decoder in a FIFO (First-In-First-Out) fashion employing two pointers in the process, one 310 for the beginning frame and one 320 for the end frame.

The purpose of the frame buffer 300 is two-fold. First, the frame buffer performs a smoothing function on the network flow. Because of network jitter, it is necessary to store several seconds worth of video prior to rendering the first video frame. Secondly, if the image buffer is nearly empty, the image buffer will send back QoS info to initiate the frame dropping process. The frame buffer is used to locate and delete candidate encoded access units, thereby speeding up the processing at the decoder. The signaling for this access unit deletion process may originate with a QoS subsystem or from the controller 109.

Namely, one of the functions of the QoS subsystem is to detect when the processor is not providing sufficient CPU resources to decode each of the presented frames in a timely manner. The QoS subsystem responds by first trying to drop independent access units (i.e., those that are not needed by other access units). For example, in MPEG-4 ASP there are three types of video access units: I-frames, P-frames, and B-frames. I-frames are completely self-contained and do not depend on any other type of frame. P and B-frames, on the other hand, are dependent on I-frames and cannot be decoded if their related I-frame is unavailable. P and B-frames have a similar relationship. If a P-frame is dropped, the dependent B-frame cannot be decoded. Therefore, in the context of MPEG-2 or MPEG-4 ASP, by first dropping B-frames over I and P-frames, the impact to subsequent frames in the image sequence is eliminated and, consequently, those remaining frames can still be decoded.

However, when additional frames beyond those available from the current pool of B- frames need to be dropped, or when no B frames are available in the video stream, such as MPEG-4 Simple Profile video stream, it becomes necessary to drop P frames. Since P frames are referenced by both P and B frames that immediately follow it, the method will only drop a P frame if the following condition is met:

T_{presentation time of next P-frame}<T_{current time}+Avg_Decode_Time (Equ. 2)

where T is the respective time.

FIG. 4 illustrates an exemplary image buffer structure 400 of the present invention. The image buffer consists of an array of decoded video images 410 arranged in a FIFO order. The image buffer data structure contains the presentation time stamps for the decoded image, thereby providing a mechanism for achieving precise audio video synchronization based on timing feedback from the audio time control component, e.g., controller 109.

Smoothing out the speed of the video decoder provides an important advantage for the MPEG-4 video decoder. In MPEG-4, not all access units require the same amount of CPU resources for decoding. Thus, without an image buffer, even if the computing resources are sufficient to decode all the frames within a certain time period, the decoder may nevertheless take longer than the frame play rate to decode a single frame and thus run behind the real-time clock. When the presentation time starts to lag, this creates undesirable side effects such as dropped frame, loss of synchronization, or frame jitter. By caching the output of the decoder in an image buffer, the effects of the occasional long decode time can be compensated for, especially when the adjacent access units are decoded with time to spare.

Thus, the present digital scheduling system 100 achieves the ability to facilitate three player related activities: precise A/V synchronization, client-based QoS management, and improved rendering performance. The latter's goals are achieved by smoothing out the effects of differences in decode time between the simplest and most complicated access units. Additionally, the management and operation of the three types of buffers can be closely tied to requirements set in accordance with a predefined QoS. For example, QoS requirements that set the size of the image buffer can also be used to set the size of the frame buffer and the frame dropping criteria. Similarly, network congestion may impact the size of the sliding window (e.g., a larger size) of the packet buffer which in turn may impact the size of the frame buffer (e.g., a larger size). The ability of the present digital scheduling system 100 to dynamically respond to changing network conditions and/or QoS requirements provides a powerful and flexible approach in effecting real-time transport of high bandwidth content over a network, e.g., an Internet Protocol (IP) network.

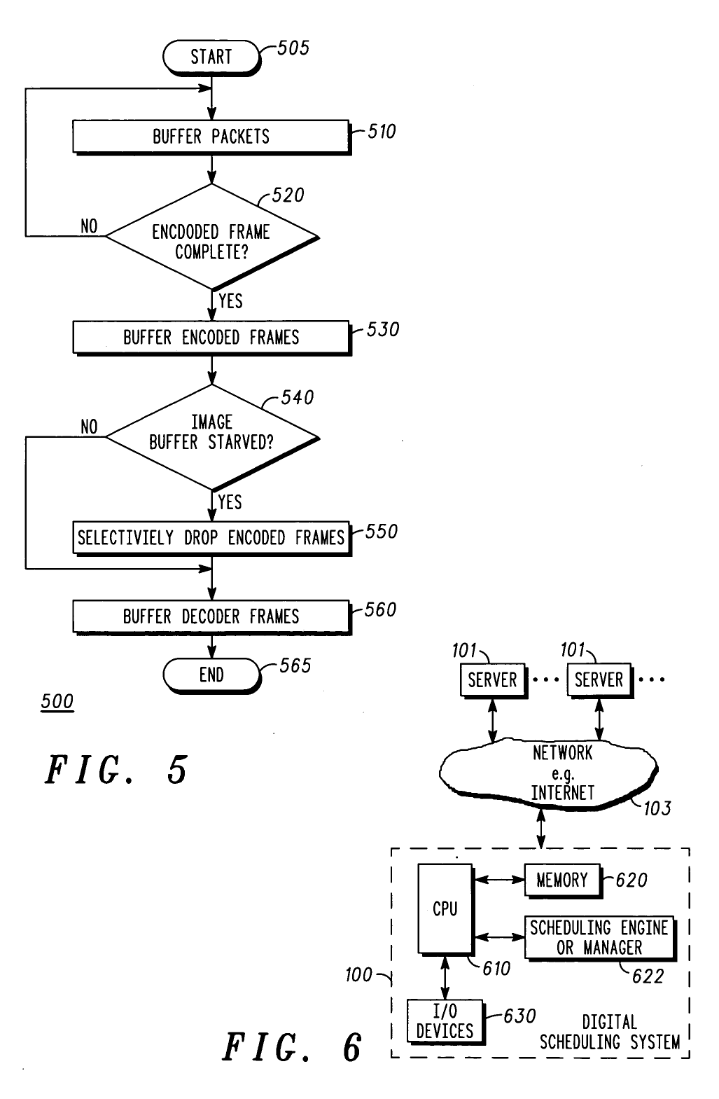

FIG. 5 illustrates a flowchart of a method 500 for implementing the buffering scheme of the digital scheduling system 100. Method 500 starts in step 505 and proceeds to step 510 where packets from a remote server are buffered into one or more packet buffers.

In step 520, method 500 queries whether the buffered packets amount to an encoded frame. Broadly, method 500 is querying whether an assembled or recovered encoded frame should be decoded and rendered. If the query is negatively answered, then method 500 returns to step 510 and continues to store incoming packets. If the query is positively answered, then method 500 assembles or passes the encoded frame and proceeds to step 530 where the encoded frame is buffered in one or more frame buffers.

In step 540, method 500 queries whether the image buffer is being starved (i.e., the image buffer is empty). If the query is answered in the affirmative, then method 500 proceeds to step 550 where encoded frames in the frame buffer are selectively dropped, e.g., starting with B frames as discussed above. If the query is negatively answered, then method 500 proceeds to step 560, where decoded frames are buffered in one or more image buffers. Method 500 ends in step 565.

FIG. 6 is a block diagram of the present digital scheduling system being implemented with a general purpose computer. In one embodiment, the digital scheduling system 100 is implemented using a general purpose computer or any other hardware equivalents. More specifically, the digital scheduling system 100 comprises a processor (CPU) 610, a memory 620, e.g., random access memory (RAM) and/or read only memory (ROM), and a digital scheduling engine, manager or application 622, and various input/output devices 630 (e.g., storage devices, including but not limited to, a tape drive, a floppy drive, a hard disk drive or a compact disk drive, a receiver, a transmitter, a speaker, a display, an output port, a user input device (such as a keyboard, a keypad, a mouse, and the like), or a microphone for capturing speech commands).

It should be understood that the digital scheduling engine, manager or application 622 can be implemented as a physical device or subsystem that is coupled to the CPU 610 through a communication channel. Alternatively, the digital scheduling engine, manager or application 622 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 620 of the computer. As such, the digital scheduling engine, manager or application 622 (including associated data structures) of the present invention can be stored on a computer readable medium or carrier, e.g., RAM memory, magnetic or optical drive or diskette and the like.

Although the present invention is described within the context of MPEG-4, those skilled in the art will realize that the present invention can be equally applied to other encoding standards, such as MPEG, MPEG-2, H.261, H.263, and the like. Additionally, although the present invention discusses frames in the context of I, P, and B frames of MPEG4, the present invention is not so limited. An I-frame is broadly defined as an intra coded picture. A P-frame is broadly defined as a predictive-coded picture and a B-frame is broadly defined as a bi-directionally predictive-coded picture. These types of frames may exist in other encoding standards under different names.

While the foregoing is directed to illustrative embodiments of the present invention, other and further embodiments of the invention may be devised without departing from the basic scope thereof, and the scope thereof is determined by the claims that follow.

1. A method of buffering packets, comprising:
receiving a plurality of packets; and
storing said plurality of packets into a buffer in accordance with at least a timestamp or a sequence number of each of said packets such that at least one placeholder is inserted between two adjacent packets having non-successive timestamps or sequence numbers.

2. The method of claim 1, wherein said buffer is implemented as a sliding window capable of being adjusted in size.

3. The method of claim 2, wherein said size of said sliding window is adjusted in accordance to a change in network condition.

4. The method of claim 2, wherein said size of said sliding window is adjusted in accordance to a predefined quality of service.

5. The method of claim 2, wherein said size of said sliding window is defined as a capacity for storing packets in accordance with a maximum network delay for said packets.

6. A method of buffering frames, comprising:
receiving a plurality of encoded frames;
storing said plurality of encoded frames into a buffer; and
deleting selectively one or more of said stored plurality of encoded frames.

7. The method of claim 6, wherein said selective deleting is performed in accordance to needing to reduce the decoder's CPU resource requirements because the requirements cannot be met by the current processor system configuration.

8. The method of claim 6, wherein said selective deleting is performed in accordance to a predefined quality of service.

9. The method of claim 6, wherein a bi-directionally predictive-coded frame from said plurality of encoded frames will be deleted first before an intra coded frame or a predictive-coded frame.

10. The method of claim 9, wherein a predictive-coded frame from said plurality of encoded frames will be deleted first before an intra coded frame.

11. A method of buffering frames, comprising:
receiving a plurality of decoded frames;
storing said plurality of decoded frames into a buffer; and
providing said decoded frames to a media renderer in a real time application.

12. The method of claim 11, wherein the buffer containing the decoded frames facilitates at least one QoS requirement.

13. The method of claim 11, wherein said real time application is a streaming media application.

14. A method of scheduling of rendered content, comprising:
buffering a plurality of packets;
assembling said plurality of packets into a plurality of encoded frames;
buffering said plurality of encoded frames;
decoding a portion of said plurality of encoded frames into a plurality of decoded frames; and
buffering said plurality of decoded frames.

15. The method of claim 14, further comprising:
forwarding said plurality of decoded frames to a rendering system.

16. The method of claim 14, wherein said buffering a plurality of packets comprises storing said plurality of packets into a buffer in accordance with at least a timestamp or a sequence number of each of said packets such that at least one placeholder is inserted between two adjacent packets having non-successive timestamps or sequence numbers.

17. The method of claim 14, wherein said buffering said plurality of encoded frames comprises:
storing said plurality of encoded frames into a buffer; and
deleting selectively one or more of said stored plurality of encoded frames.

18. The method of claim 14, wherein said buffering said plurality of decoded frames comprises:
storing said plurality of decoded frames into a buffer; and
providing said decoded frames to a media renderer in a real time application.

19. The method of claim 14, where at least one of said buffering step is adjusted in accordance to a predefined quality of service.

20. The method of claim 14, where at least one of said buffering step is adjusted in accordance to a change in network condition.

21. An apparatus for scheduling of rendered content, comprising:
a first buffer for buffering a plurality of packets;
a second buffer for buffering a plurality of encoded frames, where said plurality of encoded frames are assembling from said plurality of packets;
a decoder for decoding a portion of said plurality of encoded frames into a plurality of decoded frames; and
a third buffer for buffering said plurality of decoded frames.

22. The apparatus of claim 21, further comprising:
a rendering system for receiving said plurality of decoded frames to a rendering system.

23. The apparatus of claim 21, wherein said buffering a plurality of packets comprises storing said plurality of packets into said first buffer in accordance with at least a timestamp or a sequence number of each of said packets such that at least one placeholder is inserted between two adjacent packets having non-successive timestamps or sequence numbers.

24. The apparatus of claim 21, further comprising means for deleting selectively one or more of said stored plurality of encoded frames.

25. The apparatus of claim 22, wherein said decoded frames are provided to said rendering system in a real time application.

26. The apparatus of claim 21, where at least one of said buffering is adjusted in accordance to a predefined quality of service.

27. The apparatus of claim 21, where at least one of said buffering is adjusted in accordance to a change in network condition.

28. A computer readable carrier including program instructions that instruct a computer to perform a method of:
receiving a plurality of packets; and
storing said plurality of packets into a buffer in accordance with at least a timestamp or a sequence number of each of said packets such that at least one placeholder is inserted between two adjacent packets having non-successive timestamps or sequence numbers.

29. A computer readable carrier including program instructions that instruct a computer to perform a method of:
receiving a plurality of encoded frames;
storing said plurality of encoded frames into a buffer; and
deleting selectively one or more of said stored plurality of encoded frames.

30. A computer readable carrier including program instructions that instruct a computer to perform a method of:
buffering a plurality of packets;
assembling said plurality of packets into a plurality of encoded frames;
buffering said plurality of encoded frames;
decoding a portion of said plurality of encoded frames into a plurality of decoded frames; and
buffering said plurality of decoded frames.
